(19) United States
(12) Patent Application Publication
(10) Pub. No.: US 2006/0221627 A1
(43) Pub. Date: Oct. 5, 2006

(54) Charging unit

(76) Inventors: Alexander Osswald, Stuttgart (DE); Rainer Glauning, Aichtal-Groetzingen (DE)

Correspondence Address: STRIKER, STRIKER & STENBY, 103 EAST NECK ROAD, HUNTINGTON, NY, 11743, US

(21) Appl. No.: 11/395,866

(22) Filed: Mar. 31, 2006

(30) Foreign Application Priority Data
Apr. 4, 2005 (DE) 10 2005 015267.8

(51) Int. Cl. F21V 9/16; F21V 7/04

(52) U.S. Cl. 362/551; 362/84

(57) ABSTRACT

A charging unit has at least one housing element, and the housing element has at least a portion which is composed of a light-permeable material.

### BACKGROUND OF THE INVENTION

The present invention is directed in particular to a charging unit with at least one housing element.

A charging unit designed as a charging device is known, the charging unit including a light-impermeable housing, an illuminating unit designed as a light-emitting diode being located on a cover side of the housing. The illuminating unit is provided to transmit information about the charging process to an operator.

### SUMMARY OF THE INVENTION

Accordingly, it is an object of the present invention to provide a charging unit which is a further improvement of the existing charging units.

In keeping with these objects and with others which will become apparent hereinafter, one feature of the present invention resides, briefly stated, in a charging unit that includes at least one housing element, in which at least a portion of the housing element is made of a light-permeable material.

“Housing element” is intended to mean, in particular, a “carrying element” of the housing. Furthermore, a housing element is also intended to mean, in particular, components with a surface greater than 6 cm² in size, particularly advantageously greater than 9 cm² in size, and preferably greater than 15 cm² in size, and/or that preferably form a plurality of sides of a housing. In this context, “light” is intended to mean visible light in particular, and “light-permeable” is intended to mean, in this context in particular, permeability greater than 10% and preferably greater than 30%, and particularly preferably greater than 50%.

By using an embodiment—designed accordingly—according to the present invention, particularly good visibility of the charging unit from a great distance can be attained and, in particular, by that fact that large light-emitting surfaces and desired scattering effects can be easily attained.

With a housing element that forms at least two and preferably at least three sides of a housing that includes the housing element, a light signal can be advantageously radiated with a large angle of radiation. “Large angle of radiation” is intended to mean, in particular, an angle of radiation that is advantageously greater than 2 π steradian.

If at least one illuminating unit of the charging unit is located inside a housing that includes the housing element, an advantageous illumination of the housing element can be attained. Furthermore, radiation over a plurality of side surfaces of the housing which includes the housing element can be easily attained, and advantageous protection of the illuminating unit can be attained. Various lamps that appear reasonable to one skilled in the art can be used, e.g., incandescent lamps, fluorescent lamps, energy-saving lamps, and/or one or more light-emitting diodes. The configuration of the lamp as incandescent lamps and/or fluorescent lamps offers the advantage that the lamp can be easily replaced by the operator, e.g., if the lamp becomes defective, and economical, high-performance lamps can be used, by way of which high light intensity and a resultant increased range of the light signal can be attained.

The illuminating unit is preferably provided for transmitting charging-process information. “Charging-process information” is intended to mean, in particular, information about a state of charge, a charging time, etc. As an alternative and/or in addition, other information that also appears reasonable to one skilled in the art can be transmitted, such as information about temperature, humidity, defects, etc.

By way of this optical transmission of information, an operator can be alerted to an event that occurs in the charging process and can be simultaneously apprised of the related information. As a result, charging problems can be easily detected and eliminated in a timely manner.

In a further embodiment of the present invention, at least a portion of the illuminating unit is an optical waveguide. As a result, the light generated by a light source can be guided specifically to one and/or preferably a plurality of radiation points where, e.g., there is not enough installation space for a light source. With an embodiment designed accordingly, light can also be transmitted from one unit to another unit, by way of which a light source can be utilized for a plurality of units, light can be directed to an advantageously easily-seen area, and/or lamps can be spared, particularly in units designed for mobile use, by way of which an increase in the weight of the related mobile units resulting from additional lamps can be prevented.

It is also provided that the housing element includes at least one colored section. As a result of the eye-catching design of the colored section of the charging unit, the visibility of the charging unit can be increased. The charging unit can therefore be located quickly by an operator, for example. In addition, the use of colored light sources can be avoided. Furthermore, advantageous flexibility of information transmission can be attained by the fact that the housing element includes a plurality of colored sections, each of which has a different color. A certain color can be assigned to represent a certain type of information, for example.

Preferably, at least a portion of the housing is transparent. As a result, undesired filtering of a light signal and undesired losses can be prevented, thereby enabling the light signal to be radiated in an economical manner. Furthermore, a transparent section advantageously makes it possible to perform a visual inspection of components inside the charging unit. Furthermore, a charging unit with an illuminating unit is provided, the illuminating unit including at least one means, of which at least a portion is composed of an optical effect material. “Optical effect material” is intended to mean, in particular, a photoluminescent, in particular fluorescent and/or phosphorescent material that radiates light during and/or after excitation via irradiation with visible or ultraviolet light. In addition, “optical effect material” is intended to mean an electroluminescent material that emits light via excitation of electrical fields and/or electrical discharge processes, and a particularly reflective material, and/or a material that has thermochromic colors. By using an optical effect material, it is possible to realize, in particular, increased visibility of the charging unit and large light-emitting surfaces in an economical manner.

By using an electroluminescent material, e.g., a light-emitting foil, a space-saving means of achieving the object of the present invention can be attained in the form of a signaling device—which is controllable in a particularly flexible manner—to transmit information, and, in fact, by designing the intensity, color and/or duration of its light radiation to be variable, e.g., by implementing intermittent switching and/or pulsed operation, etc. In this context, “light-emitting foil” is intended to mean a foil, in particular, by way of which electrical energy can be converted to light energy, in particular a multilayered foil with one layer formed by a rear electrode, one layer formed by an insulator, one layer formed by a luminous material, and one layer formed by a front electrode.

By using thermochromic colors, it is possible to attain particularly advantageous transmission of information, e.g., temperature information, in particular.

Advantageously, at least a portion of the means is made of a photoluminescent material. As a result, the use of additional luminous materials be prevented, and a particularly compact illuminating unit can be created. In addition, advantageous light radiation can be attained without the use of an additional energy source and the costs associated therewith.

In a further embodiment of the present invention, at least a portion of the illuminating unit is a housing unit. As a result, an increase in the weight of the charging unit and/or additional installation space for the illuminating unit can be spared. In addition, configuring the means as a housing element enables the visibility of the charging unit to be advantageously increased further, due to the fact that a larger area—particularly preferably at least one side wall of the housing and, particularly preferably, the entire housing—is made of an optical effect material.

It is furthermore provided that the means are mounted on a carrier element. As an option, e.g., if an operator so desires, the means can be attached to the charging unit. The means can be mounted on the carrier element in a non-positive or form-fit manner, or in a bonded manner in particular, e.g., via adhesion, in particular.

Particularly advantageously, the means are designed as a detachable means, by way of which an operator can equip the charging unit with an optical effect material of his liking and/or that is tailored to certain boundary conditions, and/or by way of which an operator can replace a defective means in a particularly easy manner.

The charging unit is advantageously designed as a charging device. With this embodiment of the present invention, e.g., a plurality of rechargeable batteries can be charged in the charging unit, it being possible for an illuminating unit, e.g., in combination with at least one optical waveguide that is connected with at least one rechargeable battery, to supply the rechargeable battery with light. In addition, additional installation space for an illuminating unit of a rechargeable battery and the resultant increase in weight of the rechargeable battery can be avoided. Furthermore, a power supply device integrated in the charging unit designed as a charging device can be used advantageously, e.g., to supply power to an illuminating unit located in the rechargeable battery via a contact device of the rechargeable battery. As an alternative and/or in addition, it is also feasible, however, for the charging unit according to the present invention to be a rechargeable battery.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 Shows a charging unit in accordance with the present invention designed as a charging device,

FIG. 2 Shows a charging unit in accordance with the present invention designed as a rechargeable battery, and

FIG. 3 Shows an alternative charging unit in accordance with the present invention designed as a charging device.

### DESCRIPTION OF THE PREFERRED EMBODIMENTS

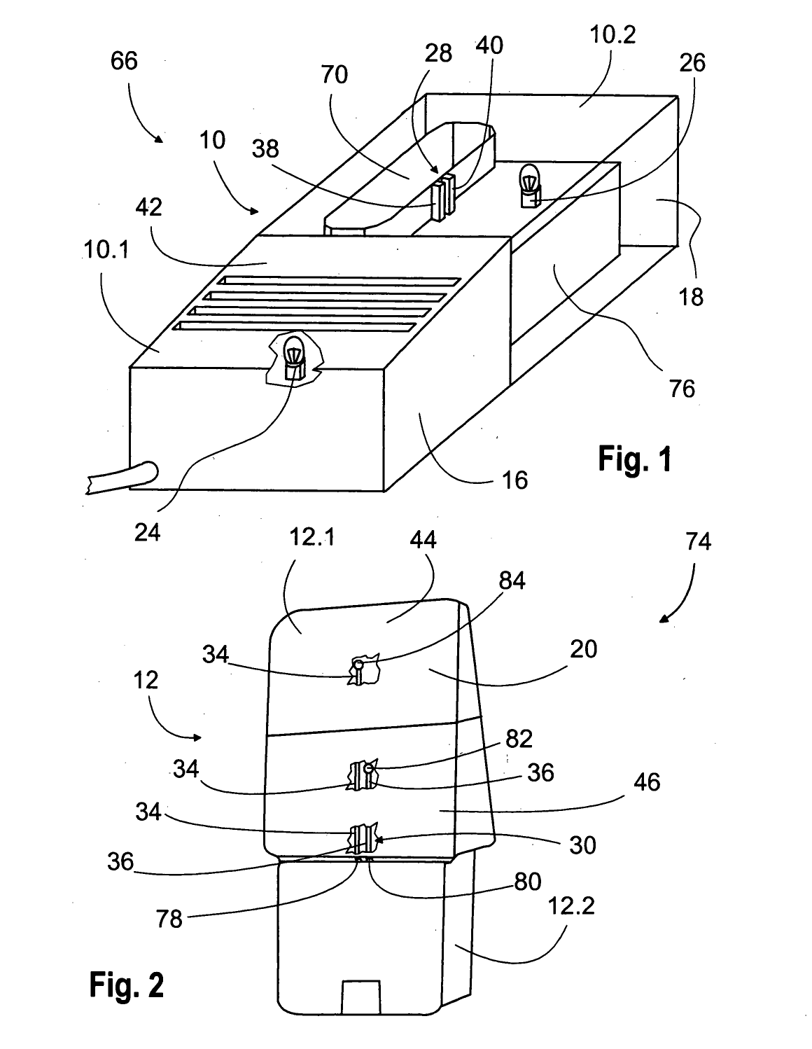

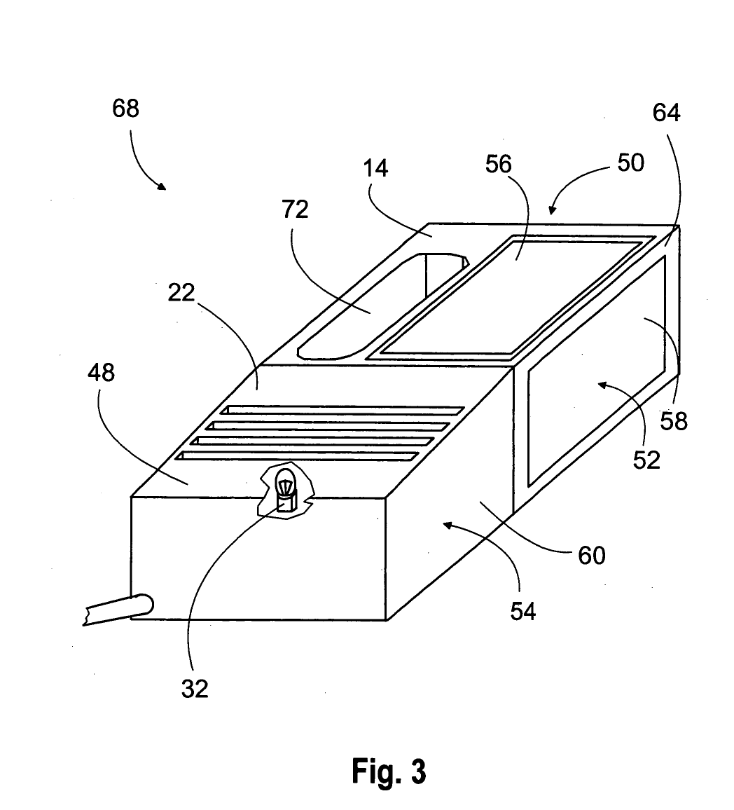

FIG. 1 and FIG. 3 each show a charging unit designed as a charging device 66 and/or 68 with a rechargeable-battery receptacle 70 and/or 72, into which a charging unit in FIG. 2 designed as a rechargeable battery 74 can be plugged.

Light-permeable materials are used to make charging device 66 and rechargeable battery 74. Charging device 66 in FIG. 1 has a housing 10 which includes a front housing part 10.1 and a rear housing part 10.2. A housing element 16 which forms three circumferential sides and the cover side of front housing part 10.1 is composed of a light-permeable material, and a housing element 18 which forms three circumferential sides and the cover side of rear housing part 10.2 is composed of a transparent material. Rechargeable battery 74 in FIG. 2 has a housing 12 with a top housing part 12.1 and a rear housing part 12.2 which is located in rechargeable-battery receptacle 70 when rechargeable battery 74 is plugged into charging device 66. A housing element 20 that forms four circumferential sides of top housing part 12.1 is made of a light-permeable material.

The use of colored materials in charging device 66 and rechargeable battery 74 makes charging device 66 and/or rechargeable battery 74 particularly noticeable. Housing element 16 of charging device 66 has a green section 42, which forms the cover side of front housing part 10.1. Housing element 20 of rechargeable battery 74 has two sections 44 and 46, which are colored red and green, respectively.

When charging device 66 is operated, housing elements 16 and 18 are each illuminated by an illuminating unit 24 and/or 26 located inside housing 10, the illuminating units each being configured as incandescent lamps. A visible light signal emitted by illuminating unit 24 is scattered via housing element 16 and is radiated further outwardly. Housing element 16 which illuminates while charging device 66 operates is easily seen in an eye-catching manner to an operator who is far away. By way of transparent housing element 18, a light signal emitted by illuminating unit 26 is radiated further outwardly by housing element 18 with minimum filtering. In addition, internal components 76 of charging device 66 can be seen by an operator.

When rechargeable battery 74 is plugged into rechargeable-battery receptacle 70, housing element 20 is illuminated by an illuminating unit 30 while charging device 66 operates, illuminating unit 30 including two optical waveguides 34 and 36 and being located inside housing 12. Rechargeable battery 74 does not have its own light source. Instead, it is supplied with light by an illuminating unit 38 of charging device 66. This is accomplished by the fact that optical waveguides 34 and 36 are connected with further optical waveguides 38 and/or 40 of illuminating unit 28 via two optical waveguide contacts 78 and/or 80 of rechargeable battery 74. The light is produced by two not-shown light-emitting diodes of illuminating unit 28 and is guided via optical waveguides 34, 36, 38 and 40 to radiation points 82 and 84 in rechargeable battery 74.

During the process of charging rechargeable battery 74, information about this charging process can be communicated to an operator in a visual manner. During operation of charging device 66, a green section 46 illuminates to indicate that a rechargeable battery 74 is plugged in. In addition, the operator is notified about the state of charge of rechargeable battery 74 via an illuminated red section 44, i.e., by the fact that the light intensity of the radiated signal is proportional to the state of charge of rechargeable battery 74. If rechargeable battery 74 is defective or if the temperature of rechargeable battery 74 becomes excessive, the operator can be alerted to the problem via blinking of red section 46.

The information can also be transmitted visually by charging device 66. The end of the charging process of rechargeable battery 74 or an interruption of this charging process caused by a defect in charging device 66 and/or rechargeable battery 74 is indicated via blinking of illuminating unit 26. Green section 42 illuminates to indicate, in a simple manner, that charging device 66 is operating. In addition, other combinations of colors, light intensities, blinking frequencies, etc. are feasible methods of visually transmitting information.

With a charging device 68 shown in FIG. 3, further optical signaling techniques based on the use of optical effect materials are used. Charging device 68 includes three illuminating units 50, 52 and 54, each of which has a means made of an optical effect material.

Illuminating unit 50 includes a means 56 designed as a light-emitting foil. During a charging process of rechargeable battery 74, the light-emitting foil displays images that transmit, to the operator, the information described above regarding the state of charge, with a greater depth of information. In addition, the charging time and temperature of charging device 68 are displayed.

Illuminating unit 52 includes a means 58, which is designed as a fluorescent adhesive. Means 58 is mounted on a housing element of a housing 14 serving as carrier element 64 and is connected with it in a bonded manner, e.g., via adhesion. Means 58 is formed by a fluorescent material and contributes—without an additional energy source—to enhanced visibility of charging device 68. Means 58 is detachable and can be easily replaced by an operator.

Illuminating unit 54 includes a means 60 designed as a housing element composed of a phosphorescent material. With the aid of phosphorescent means 60, charging device 68 can radiate light without being supplied with power and, as a result, it can be located quickly by an operator, in a dark room in particular.

Combined use of optical effect materials and light-permeable materials is realized with charging device 68. Charging device 68 includes a housing element 22 made of a light-permeable material. During operation of charging device 68, housing element 22 is illuminated by an illuminating uint 32 located inside housing 14, and the light signal radiated by illuminating unit 32 is scattered via housing element 22 and radiated outwardly. Housing element 22 also includes a green section 48.

It will be understood that each of the elements described above, or two or more together, may also find a useful application in other types of constructions differing from the types described above.

While the invention has been illustrated and described as embodied in a charging unit, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A charging unit, comprising at least one housing element, said housing element having at least a portion which is composed of a light-permeable material.

2. A charging unit as defined in claim 1; and further comprising at least one illuminating unit located inside a housing that includes said housing element.

3. A charging unit as defined in claim 2, wherein said illuminating unit is configured as an illuminating unit for transmitting charging process information.

4. A charging unit as defined in claim 2, wherein said illuminating unit has a portion which is configured as an optical waveguide.

5. A charging unit as defined in claim 1, wherein said housing element includes at least one colored section.

6. A charging unit as defined in claim 1, wherein said portion of said housing element is transparent.

7. A charging unit as defined in claim 2, wherein said illuminating unit includes means having a portion composed of an optical effect material.

8. A charging unit as defined in claim 7, wherein said portion of said means of said illuminating unit is composed of a photoluminescent material.

9. A charging unit as defined in claim 7, wherein a portion of said means of said illuminating unit is composed of the housing element.

10. A charging unit as defined in claim 7; and further comprising a carrier element, said means of said illuminating unit being mounted on said carrier element.

11. A charging unit as defined in claim 1, wherein the charging unit is configured as a charging device.
